(19) United States
(12) Patent Application Publication
(10) Pub. No.: US 2019/0078443 A1
(43) Pub. Date: Mar. 14, 2019

(54) FILM COOLING HOLE IN GAS TURBINE COMPONENTS

(71) Applicant: Siemens Aktiengesellschaft, Munich (DE)

(72) Inventors: Thomas Beck, Panketal (DE); Stefan Dahlke, Mülheim a.d. Ruhr (DE); Jens Dietrich, Falkensee (DE); Sebastian Hohenstein, Düsseldorf (DE)

(73) Assignee: Siemens Aktiengesellschaft, Munich (DE)

(21) Appl. No.: 16/085,176

(22) PCT Filed: Mar. 22, 2017
(86) PCT No.: PCT/EP2017/056834

§ 371 Date: Sep. 14, 2018

(30) Foreign Application Priority Data
Mar. 23, 2016 (DE) 10 2016 204 824.4

(51) Int. Cl. F01D 5/18

(52) U.S. Cl. CPC F01D 5/186; F05D 2260/202; F05D 2250/324; F05D 2250/52; F23R 2900/03042

(57) ABSTRACT

A film-cooling hole of gas turbine components to be cooled has an inflow section which has a constant throughflow cross section and which is adjoined by a diffuser section which has a varying throughflow cross section. The widening of the diffuser region occurs only in the direction which is perpendicular to the flow direction of the relatively hot medium.

### CROSS REFERENCE TO RELATED APPLICATIONS

This application is the US National Stage of International Application No. PCT/EP2017/056834 filed Mar. 22, 2017, and claims the benefit thereof. The International Application claims the benefit of German Application No. DE 102016204824.4 filed Mar. 23, 2016. All of the applications are incorporated by reference herein in their entirety.

### FIELD OF INVENTION

The invention relates to film-cooling holes of gas turbine components to be cooled. Gas turbine components which have film-cooling holes may for example be turbine blades, ring segments or else combustion chamber components.

### BACKGROUND OF INVENTION

With the aid of the film-cooling holes, a cooling air film can be produced on surfaces of the components to be cooled, over which surfaces hot gas is able to flow, said film being intended to protect these surfaces against direct contact, and thus against the thermal influences, of the hot gas flowing along them.

For example, EP 0 227 578 A2 and also EP 0 945 593 A1 disclose a conventional film-cooling air hole, in which a round inlet is adjoined by a diffuser-like region. According to EP 0 945 593 A1, the outlet opening of the diffuser may have different geometric shapes, whereas US 2012/0051941 A1 proposes forming the base of the diffuser not in a rectilinear manner but in a curved manner. Furthermore, WO 01/43912 A1 discloses a film-cooling hole with a funnel-shaped opening. In all cases, due to the diffuser-like region, a fanning-out of the outflowing cooling air in the lateral direction is made possible. However, as a result of increasing combustion temperatures and increasing demands on the efficiency of gas turbines, there is furthermore a particular interest in the provision of a film-cooling hole with an increased cooling capacity with a low use of cooling air.

### SUMMARY OF INVENTION

It is an object of this invention to provide a film-cooling hole by way of which particularly efficient film cooling is able to be achieved.

Said object is achieved by way of a film-cooling hole as per the independent claim. Advantageous refinements are specified in the dependent claims, wherein the features of the dependent claims may, even only partially, be combined with one another in any desired manner.

### BRIEF DESCRIPTION OF THE DRAWINGS

In the figures:

FIG. 1 shows a conventional film-cooling hole with counter-rotating vortex pairs,

FIG. 2 shows the conventional film-cooling hole in a cross section

FIG. 3 shows the conventional film-cooling hole in a plan view,

FIG. 4 shows a film-cooling hole according to the invention in a perspective view,

FIG. 5 shows the film-cooling hole according to the invention with counter-rotating vortex pairs,

FIG. 6 shows a cross section through a component wall having the film-cooling hole according to the invention, and

FIG. 7 shows a plan view, perpendicular to the first surface, of the film-cooling hole according to the invention.

### DETAILED DESCRIPTION OF INVENTION

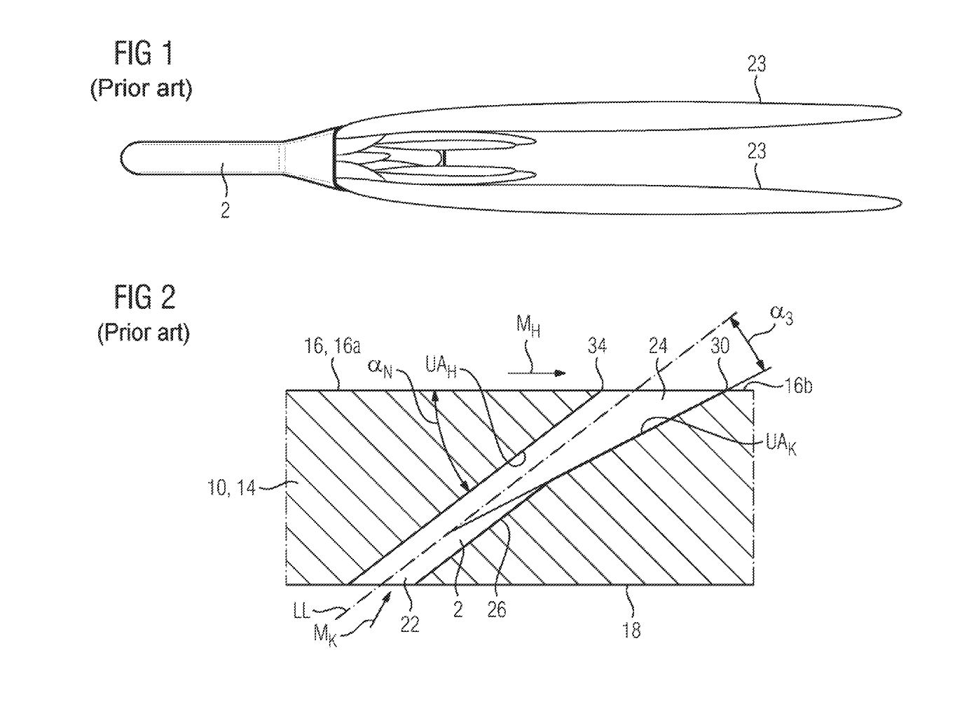

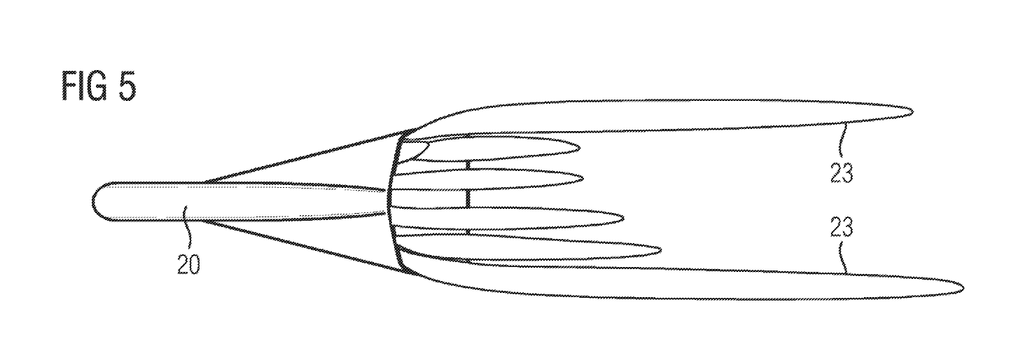

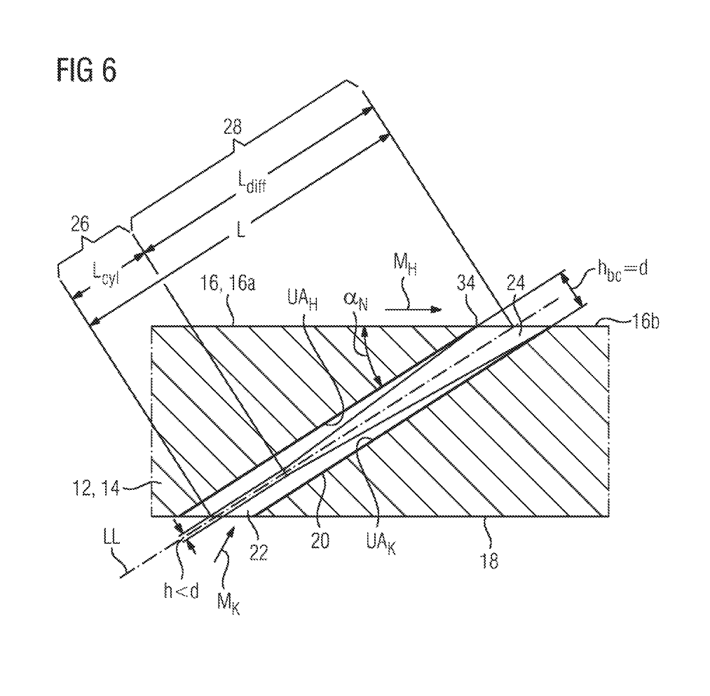

The invention and the film-cooling hole 20 according to the invention are illustrated in FIGS. 4 to 7, whereas FIGS. 1 to 3 show a film-cooling hole 2 which is already known. Both in the illustration of the invention and in the illustration of the prior art, identical features are provided with the same reference signs.

Each of the film-cooling holes 2, 20 shown is formed in a wall 14 as a passage hole, which wall is able to be subjected to hot gas, such that said hole extends from a first surface 16 of the wall 14 to a second surface 18, opposite said first surface, of the wall 14. When the invention is used as intended, a relatively hot medium M_{H} flows over the first surface 16, whereas the second surface 18 is at the same time exposed to a relatively cool medium M_{K}. Normally, the relatively hot medium is a working medium and the relatively cool medium is cooling air. The wall 14 may for example be a constituent part of a turbine blade of a turbomachine, of a ring segment, of a combustion chamber wall or of the like, and in this case have one or more rows with such or similar film-cooling holes 2, 20.

The film-cooling holes 2, 20 in question are arranged so as to be inclined in relation to the surfaces 16, 18. Each film-cooling hole 2, 20 comprises an inflow opening 22 which is arranged in the second surface 18. The relatively cool medium is able to flow into the film-cooling hole in question through said inflow opening 22. The medium which has flowed in exits the film-cooling hole 2, 20 in question through an outflow opening 24 which is arranged in the first surface 16.

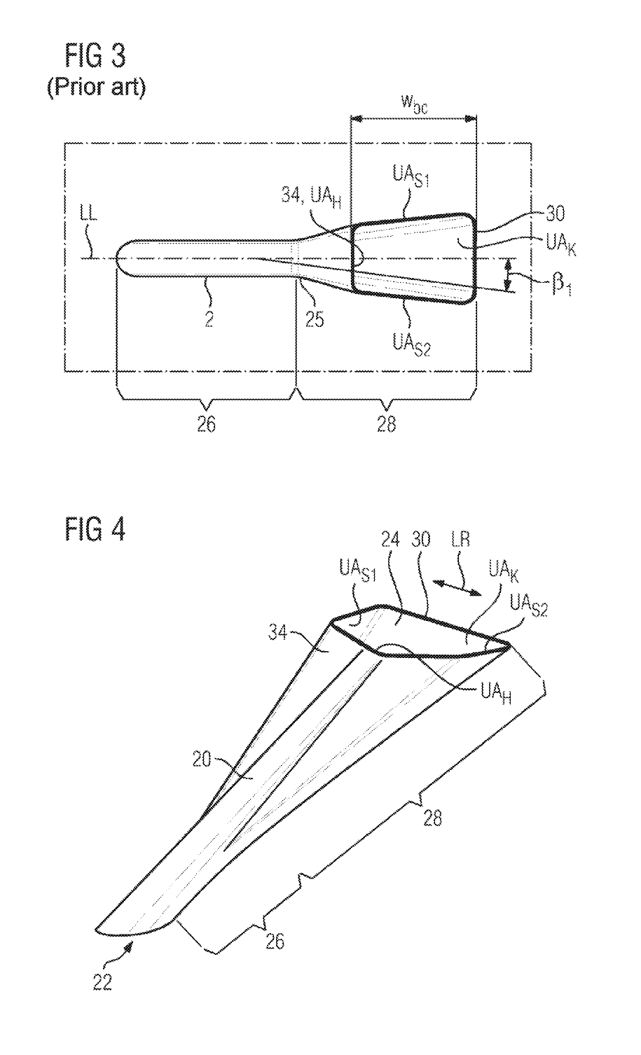

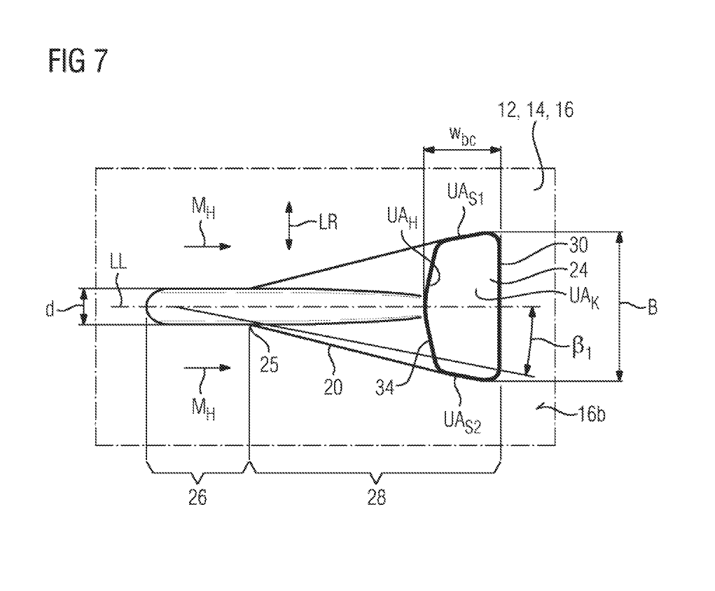

As emerges from FIGS. 3 and 7, a first longitudinal section of the film-cooling hole 2, 20, hereinafter referred to as inflow section 26, extends from the inflow opening 22 to a transition point 25 and in this case has a constant throughflow diameter d. The throughflow quantity of exiting medium M_{K} is able to be set by means of said diameter d. From the transition point 25, both the size of the cross section of the film-cooling hole, through which cross section flow can pass, and its contour vary. With regard to the relatively cool medium M_{K} flowing through the film-cooling hole, a continuously varying diffuser section 28 which extends to the outflow opening 24 consequently immediately follows downstream of the transition point 25.

Each film-cooling hole has a virtual longitudinal axis LL which extends through the midpoints of the inflow section 26 and extends therebeyond. The film-cooling holes 2, 20 in question are inclined in relation to the first surface 16 such that the virtual central longitudinal axis LL includes—in a cross-sectional view through the wall 14 in question—an acute inclination angle α_{N} with an upstream region 16a of the second surface 16.

When viewed along the virtual longitudinal axis LL, the inflow section 26 has the length L_{cyl} and the diffuser section 28 has the length L_{diff}, which lengths can be combined to form a hole length L.

In particular, the diffuser section 28 of the film-cooling hole 2, 20 comprises four individually identifiable side walls, which are referred to hereinafter as peripheral sections and transition into one another along the periphery. A first peripheral section UA_{H} has a relatively small spacing to the first surface 16 and thus faces the relatively hot medium M_{H}. Said peripheral section UA_{H} ends at a diffuser edge 34 which is on the inflow side in relation to the relatively hot medium M_{H}, on the one hand, and transitions laterally on both sides into in each case one lateral peripheral section UA_{S1}, UA_{S2}, on the other hand. The two lateral peripheral sections UA_{S1}, UA_{S2} each then transition into a common peripheral section UA_{K}, which has a relatively small spacing to the second surface 18 and thus faces the relatively cool medium M_{K}. The further peripheral section UA_{K} consequently ends at a diffuser edge 30 which is on the outflow side in relation to the relatively hot medium M_{H} and which is advantageously substantially rectilinear. Overall, a spacing w_{bc} can be determined between the inflow-side diffuser edge 34 and the outflow-side diffuser edge 30.

In the exemplary embodiment shown, the walls of the lateral peripheral sections UA_{S1}, UA_{S2} are of substantially rectilinear form.

In a cross-sectional view (cf. FIG. 1), the peripheral section UA_{K} which faces the relatively cool medium includes a so-called rear-position angle α₃ with the virtual longitudinal axis LL. In a perpendicular projection (as per FIG. 3) onto the first surface 16, an opening angle β₁ may be recorded in each case between the lateral peripheral sections UA_{S1}, UA_{S2} of the diffuser section 28 and the virtual central longitudinal axis LL.

According to the invention, it is provided that the enlargement of the throughflow cross section, which increases in the diffuser section 28 of the film-cooling hole 20, is realized in one dimension only (lateral dimension LR). For this purpose, it is provided that the rear-position angle α3 has a value of between 1° and 0°. Consequently, the increase of the throughflow cross section is realized mainly in that the lateral peripheral sections UA_{S1}, UA_{S2} of the film-cooling hole 20 diverge, whereas, in the diffuser section 28, the spacing at the outflow opening 24 between the peripheral section UA_{H} which faces the relatively hot medium M_{H} and the peripheral section UA_{K} which faces the relatively cool medium Mk becomes at most only insignificantly larger than the diameter d of the inflow section 26.

In this way, the area ratio is enlarged: for a given mass flow of relatively cool medium through the film-cooling hole 20 in question, the flow speed at the outflow opening 24 of the film-cooling hole 20 is able to be reduced in comparison with a conventional film-cooling hole 2, as a result of which the tendency of the exiting jet of relatively cool medium M_{K} to detach from the first surface 16 can be reduced.

Preferably, the length L_{diff} of the diffuser section 28, which is able to be recorded between the transition point 25 and the outflow opening 24, is greater than 7 times the diameter d of the inflow section 26. In this way, it is achieved that the diffuser section is relatively long and is thus able to widen sufficiently. During operation, it is then possible for a relatively wide cooling-air film to form.

It is particularly advantageous if, immediately downstream of the transition point 25, the diffuser section 28 has—in a cross-sectional view through the wall 14 in question—a diffuser height h which is less than the diameter d of the inflow section 26. Preferably, said height is less than 50% of the diameter d. The diffuser entry thus starts with a relatively gentle diffuser widening, this reducing the tendency of the cooling-air flow to detach. Moreover, the diffuser-like widening of the film-cooling hole 20 does not start at that section of the periphery of the film-cooling hole 20 which is closest to the second surface 18, but at the two lateral sections of the periphery. In this way, fanning-out of the flow in the interior of the film-cooling hole 20 with lower losses can be achieved since a pressure distribution which is less asymmetrical but rather made more uniform occurs.

Also, a width B of the outflow opening 24, which is able to be recorded perpendicular to the flow direction of the relatively hot medium M_{H}, is greater than in the case of conventional film-cooling holes 2 with comparable diffuser opening ratios. This positively influences the counter-rotating vortex pairs 23, which normally arise at the outer lateral boundaries of the outflow opening 24, that is to say at the imaginary extensions of the lateral peripheral sections UA_{S1} and UA_{S2}. At the same time, this has an influence of the first order on the mixing process of relatively cool medium M_{K} and relatively hot medium M_{H}. As shown in FIG. 5, the spacing between the two flanks of the counter-rotating vortex pairs 23 can be enlarged by way of the proposed design. In this way, the relatively cool medium M_{K} flowing out in the region of the virtual central longitudinal axis LL is influenced to a lesser extent by the counter-rotating vortex pairs 23, which reduces the mixing. Also, the intensity of the counter-rotating vortex pairs 23 can thereby be reduced. As a result, this leads to an enlarged covering of the first surface 16 with the desired cooling-air film.

Further, the relatively large spreading, that is to say the enlarged opening angle β₁, in comparison with the prior art, of the diffuser section 28 in that direction (lateral direction LR) which is perpendicular to the flow direction of the relatively hot medium M_{H}, leads to a more uniform distribution of the relatively cool medium M_{K} at the outflow opening 24. In this way, it is possible to reduce local overcooling of the first surface 16 in the central region of the virtual longitudinal axis LL immediately downstream of the outflow-side diffuser edge 30. Overall, it is thus possible for the cooling to be made more uniform. For this reason, the opening angle β₁ is not greater than 12°. Preferably, it is 11.5°.

Preferably, the inflow-side diffuser edge 34 is of symmetrically curved form, wherein its central region is arranged slightly further upstream than its lateral ends. Consequently, the film-cooling hole 20 is relatively simple to produce since first of all the inflow section is drilled and then the contour of the diffuser section can be produced.

All of the above-mentioned advantages lead overall to an increase in adiabatic film-cooling effectiveness in comparison with conventional film-cooling holes. In particular, further downstream of the film-cooling hole, the average film-cooling effectiveness of the film-cooling hole according to the invention is superior to the effectiveness of conventional film-cooling holes.

Overall, the invention relates to a film-cooling hole 20 of gas turbine components to be cooled, having an inflow section 26 which has a constant throughflow cross section and which is adjoined by a diffuser section 28 which has a varying throughflow cross section. In order to provide particularly efficient film cooling, it is proposed that the widening of the diffuser region 26 occurs only in the lateral direction LR.

1.-8. (canceled)

9. A cooled component for a turbine, comprising:
a wall which is delimited by a first surface and by a second surface which is opposite the first surface, wherein the first surface is adapted to be flowed around by a relatively hot medium, which is able to flow from an upstream region to a downstream region, and wherein the second surface is adapted to come into contact with a relatively cool medium,
at least one film-cooling hole which is inclined with respect to the second surface and which serves for passage of the relatively cool medium to the second surface through the wall,
wherein the film-cooling hole comprises:
an inflow opening which is arranged in the second surface and through which the relatively cool medium is able to flow into the film-cooling hole,
an outflow opening which is arranged in the first surface and through which the relatively cool medium, which is able to flow in an interior of the film-cooling hole, is able to exit the film-cooling hole,
a virtual central longitudinal axis which extends by a hole length from the inflow opening to the outflow opening,
four peripheral sections which transition into one another successively one after the other along a periphery which is tangential to the longitudinal axis, comprising: a peripheral section (UA_{H}) which faces the relatively hot medium, a first lateral peripheral section (UA_{S1}), a peripheral section (UA_{K}) which faces the relatively cool medium, and a second lateral peripheral section (UA_{S2}),
an inflow section which is arranged between the inflow opening and a transition point and which has a constant throughflow cross section, and
a diffuser section which is arranged from the transition point to the outflow opening and which has a throughflow cross section which increases in this direction,
an outflow-side diffuser edge which is adjoined at the second surface by the peripheral section (UA_{K}) which faces the relatively cool medium,
an inflow-side diffuser edge which is adjoined at the second surface by the peripheral section (UA_{H}) which faces the relatively hot medium, and
a spacing (w_{bc}) between the inflow-side diffuser edge and the outflow-side diffuser edge,
wherein the inclination of the film-cooling hole in relation to the first surface is such that the virtual central longitudinal axis includes, in a cross-sectional view through the wall in question, an acute inclination angle (α_{N}) with the upstream region of the second surface, and
wherein the peripheral section (UA_{K}) which faces the relatively cool medium includes, in a cross-sectional view through the wall in question, a rear-position angle (α₃) with the virtual longitudinal axis,
wherein the rear-position angle (α₃) has a value which is less than 1°,
wherein, immediately downstream of the transition point, the diffuser section has, in a cross-sectional view through the wall in question, a diffuser height (h) which is less than a diameter (d) of the inflow section.

10. The component as claimed in claim 9,
wherein a length (L_{diff}) of the diffuser section, which is able to be recorded between the transition point and the outflow opening, is greater than 7 times the diameter (d) of the inflow section.

11. The component as claimed in claim 9,
wherein, in a perpendicular projection with respect to the first surface, the lateral peripheral sections (UA_{S1}, UA_{S2}) of the diffuser section are of rectilinear form, and said sections include an opening angle (β₁) of at least 11.5° with the virtual central longitudinal axis.

12. The component as claimed in claim 9,
wherein the outflow-side diffuser edge is substantially straight.

13. The component as claimed in claim 9,
wherein the inflow-side diffuser edge is curved.

14. The component as claimed in claim 9,
wherein the spacing (w_{bc}) substantially corresponds to the diameter (d) of the inflow section divided by a sine of the inclination angle (α_{N}): w_{bc}=d/sind (α_{N}).

15. The component as claimed in claim 9, comprising:
a multiplicity of corresponding film-cooling holes arranged in one or more rows.
